(19) United States
(12) Patent Application Publication
(10) Pub. No.: US 2014/0360987 A1
(43) Pub. Date: Dec. 11, 2014

(54) LASER APPARATUS AND METHOD OF IRRADIATING LASER BEAM USING THE SAME

(71) Applicant: Samsung Display Co., LTD., Yongin-City (KR)

(72) Inventors: Hee-Geun SON, Busan (KR); Byoung-Kwon CHOO, Hwaseong-si (KR); Do-Yeob KIM, Daegu (KR)

(73) Assignee: Samsung Display Co., LTD., Yongin-City (KR)

(21) Appl. No.: 14/291,711

(22) Filed: May 30, 2014

(30) Foreign Application Priority Data
Jun. 5, 2013 (KR) 10-2013-0064504

(51) Int. Cl. B23K 26/30

(52) U.S. Cl. CPC B23K 26/422
USPC 219/121.61

(57) ABSTRACT

A laser apparatus includes: a laser which selectively irradiates a laser beam to a portion of a target based on a laser driving voltage, where an intensity of the laser beam is substantially stabilized within about 10 nanoseconds; a stage which controls a relative location between the target and the laser based on a stage driving voltage; and a controller which applies the stage driving voltage to the stage, and applies the laser driving voltage to the laser

This application claims priority to Korean Patent Applications No. 10-2013-0064504, filed on Jun. 5, 2013, and all the benefits accruing therefrom under 35 U.S.C. §119, the content of which in its entirety is herein incorporated by reference.

### BACKGROUND

1. Field

Exemplary embodiments relate generally to a laser apparatus and a method of irradiating laser beam using the laser apparatus. More particularly, exemplary embodiments of the invention relate to a laser apparatus having improved preciseness and a method of irradiating laser beam using the laser apparatus with improved yield.

2. Description of the Related Art

A display apparatus may include an organic light emitting element, a thin film transistor for driving the organic light emitting element and a plurality of lines connected to the thin film transistor. The thin film transistor typically includes a semiconductor pattern. The semiconductor pattern of the thin film transistor includes amorphous silicon or polysilicon, for example.

The thin film transistor including the amorphous silicon is efficiently formed through a relatively simple manufacturing process. However, the thin film transistor including the amorphous silicon may have low electric conductivity and slow response speed. The thin film transistor including the polysilicon is formed through a relatively complex manufacturing process. However, the thin film transistor including the polysilicon has high electric conductivity and high response speed, for example.

Image display quality of a light emissive type display apparatus such as an organic light emitting display apparatus may depend on electric characteristics of the thin film transistor. Thus, a portion of elements of the organic light emitting display apparatus may include the thin film transistor including the polysilicon.

In a method of forming the polysilicon on a substrate, an amorphous silicon layer is typically formed on the substrate, and then the amorphous silicon layer is crystallized to form the polysilicon.

The method of crystallizing the amorphous silicon into the polysilicon is classified into a heating method and a laser irradiating method, for example. In the heating method, the substrate including the amorphous silicon is typically heated in a chamber, and an entire of the substrate is heated such that electric characteristics of other elements may also be changed. In the laser irradiating method, the laser is irradiated onto only amorphous silicon. However, preciseness of the polysilicon is decreased based on irradiation characteristics of the laser.

### SUMMARY

Exemplary embodiments of the invention provide a laser apparatus having improved preciseness.

Exemplary embodiments also provide a method of irradiating laser beam using the laser apparatus with improved yield.

According to an exemplary embodiment, a laser apparatus includes: a laser which selectively irradiates a laser beam to a portion of a target based on a laser driving voltage, where an intensity of the laser beam is substantially stabilized within about 10 nanoseconds (ns); a stage which controls a relative location between the target and the laser based on a stage driving voltage; and a controller which applies the stage driving voltage to the stage, and applies the laser driving voltage to the laser.

In an exemplary embodiment, the laser may irradiate the laser beam through an advanced excimer laser annealing method.

In an exemplary embodiment, the target may include a base layer and a silicon layer disposed on the base layer.

In an exemplary embodiment, the target may have an irradiation region, in which the laser beam is irradiated, and a non-irradiation region, in which the laser beam is not irradiated.

In an exemplary embodiment, when the laser selectively irradiates the laser beam to the portion of the target, the irradiation region may include polysilicon, the non-irradiation region may include amorphous silicon, and when the laser selectively irradiates the laser beam to the portion of the target, the target may further include a transition region interposed between the irradiation and non-irradiation regions, where the transition region includes a mixture of polysilicon and amorphous silicon.

In an exemplary embodiment, the controller may have a single module structure.

In an exemplary embodiment, the controller may generate the laser driving voltage and the stage driving voltage based on an input signal.

In an exemplary embodiment, the controller may generate the laser driving signal, a compensation signal based on the laser driving signal, and a laser driving voltage based on the laser driving signal and the compensation signal.

In an exemplary embodiment, the controller may include an information processing unit which generates the laser driving signal, a laser driving unit which generates the laser driving voltage, and a stage driving unit which generates the stage driving voltage.

In an exemplary embodiment, the controller may change a stage driving signal into the stage driving voltage.

In an exemplary embodiment, a starting time point of the stage driving signal may be different from a starting time point of the stage driving voltage.

In an exemplary embodiment, the starting time point of the stage driving voltage may precede the starting time point of the stage driving signal.

In an exemplary embodiment, the stage may include a location controlling part which controls a location of the target thereon, and an acceleration-deceleration controlling part which controls an acceleration of the target.

According to an exemplary embodiment, a method of irradiating a laser beam includes: driving a stage of the laser apparatus based on a stage driving voltage, where the stage controls a relative location between a target of the laser apparatus and a laser beam irradiated from a laser of the apparatus; generating a laser driving voltage based on a laser driving signal and a compensation signal, which are generated from a controller of the laser apparatus; and irradiating the laser beam generated based on the laser driving voltage from the laser to the target.

In an exemplary embodiment, the irradiating the laser beam generated based on the laser driving voltage from the laser to the target may include: transporting the stage in a vertical direction to irradiate the laser beam in an irradiation region of the target; and transporting the stage in a horizontal direction without irradiating the laser beam.

In an exemplary embodiment, the compensation signal may have a high voltage level during an initial stage of the irradiating the laser beam.

In an exemplary embodiment, the compensation signal may be applied during about 100 ns from a rising time point of the laser driving signal.

In an exemplary embodiment, a voltage level of the compensation signal may have a maximum level at a rising time point of the laser driving signal, and then may substantially continuously decrease after the rising time point of the laser driving signal.

In an exemplary embodiment, an intensity of the irradiated laser beam may be stabilized within about 10 ns.

In an exemplary embodiment, the stage may be driven at a different starting time point from the irradiating the laser beam.

In exemplary embodiments of the invention, initial response speed of the laser apparatus is substantially improved, and a preciseness of the laser apparatus is thereby improved. In such embodiments, the laser apparatus decreases defects in crystallizing. Thus, defects such as a black line of a display substrate is decreased when the display substrate is manufactured using the laser apparatus, such that image display quality of a display apparatus is substantially improved.

### BRIEF DESCRIPTION OF THE DRAWINGS

The above and other features of the invention will become more apparent by describing in detail exemplary embodiments thereof with reference to the attached drawings, in which:

FIG. 1 is a block diagram illustrating an exemplary embodiment of a laser apparatus according to the invention.

FIG. 2 is a perspective view illustrating a portion of the laser apparatus of FIG. 1.

FIG. 3 is a cross-sectional view illustrating an exemplary embodiment of a method of crystallizing using the laser apparatus of FIG. 1.

FIG. 4A is a block diagram illustrating an exemplary embodiment of a controller of FIG. 1.

FIG. 4B is a block diagram illustrating an exemplary embodiment of a stage of FIG. 1.

FIG. 5 is a timing diagram illustrating signals and an intensity of laser irradiation of an exemplary embodiment of a laser apparatus according to the invention.

FIG. 6 is a timing diagram illustrating signals and an intensity of laser irradiation of an exemplary embodiment of a laser apparatus shown in FIG. 1.

FIG. 7 is a timing diagram illustrating signals and an intensity of laser irradiation of an alternative exemplary embodiment of a laser apparatus according to the invention.

FIG. 8 is a timing diagram illustrating signals and an intensity of laser irradiation of another alternative exemplary embodiment of a laser apparatus according to the invention.

### DETAILED DESCRIPTION

Various exemplary embodiments will be described more fully hereinafter with reference to the accompanying drawings, in which exemplary embodiments are shown. The invention may, however, be embodied in many different forms, and should not be construed as limited to the exemplary embodiments set forth herein. Rather, these exemplary embodiments are provided so that this disclosure will be thorough and complete, and will fully convey the scope of the invention to those skilled in the art. Like numerals refer to like elements throughout.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

The terminology used herein is for the purpose of describing particular exemplary embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

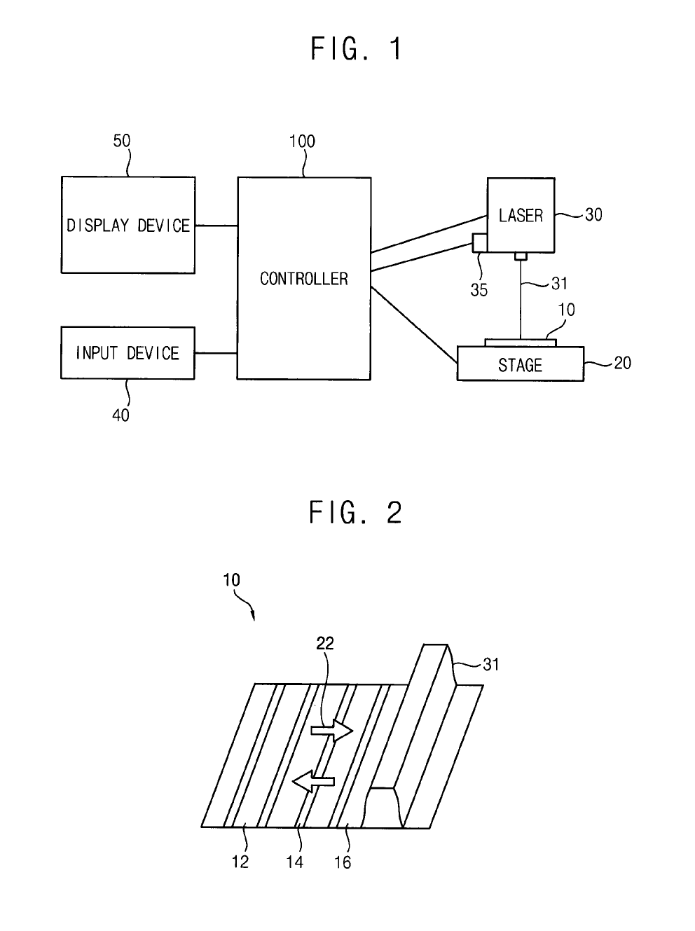

FIG. 1 is a block diagram illustrating an exemplary embodiment of a laser apparatus according to the invention.

Referring to FIG. 1, the laser apparatus includes a stage 20, a laser 30, a camera 35, an input device 40, a display device 50 and a controller 100.

In such an embodiment, a target, on which a laser beam 31 is irradiated, is disposed on the stage. In one exemplary embodiment, for example, the target, on which the laser beam 31 is irradiated, includes a substrate 10.

The laser 30 is disposed on the stage 20 to irradiate the laser beam 31 on the target, e.g., the substrate 10 disposed on the stage 20. The laser beam 31 includes an excimer laser or a continuous wave (“CW”) laser, for example. In one exemplary embodiment, for example, a relative location between the stage 20 (or the target, e.g., the substrate 10, on the stage 20) and the laser 30 is controlled such that the laser beam 31 is irradiated substantially precisely on a predetermined location of the substrate 10.

In an exemplary embodiment, the camera 35 is disposed on a side of the laser 30 or under the laser 30 to detect the position of the laser 30 with respect to the stage 20, e.g., to take a picture of a light spot of the laser beam 31 on the stage or the target (e.g., the substrate 10) under the laser 30. In one exemplary embodiment, for example, the relative location between the laser 30 and the stage 20 (or the target, e.g., the substrate 10, on the stage 20) is sensed by the camera 35 based on the detected position of the laser 30 with respect to the stage 20.

The input device 40 generates an input signal based on an input of a user. The input signal generated by the input device 40 is transmitted to the controller 100. The input of the user may include controlling of the relative location between the stage 20 (or the target, e.g., the substrate 10, on the stage 20) and the laser 30, controlling of an image displayed on the display device 50, controlling of driving of the laser 30, controlling of driving of the camera 35, for example.

In an exemplary embodiment, the display device 50 displays information on the detected position of the laser 30 with respect to the stage 20 (or the target, e.g., the substrate 10, on the stage 20), e.g., an image of the light spot of the laser beam 31 on the stage 20 (or on the target, e.g., the substrate 10) taken by the camera 35. The user perceives the image displayed on the display device 50 to perform the input using the input device 40.

In an exemplary embodiment, the controller 100 changes the image taken by the camera 35 into an image signal and outputs the image signal to the display device 50. In an exemplary embodiment, the controller 100 may receive the input signal from the input device 40 to drive the laser 30 and the stage 20. In such an embodiment, the controller 100 may control the relative location between the laser 30 and the stage 20 (or the target, e.g., the substrate 10, on the stage 20), or the operation of the laser 30, for example, based on the input signal.

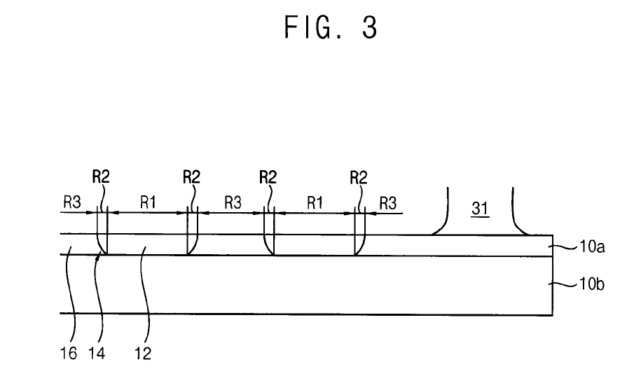

FIG. 2 is a perspective view illustrating a portion of the laser apparatus of FIG. 1. FIG. 3 is a cross-sectional view illustrating an exemplary embodiment of a method of crystallizing using the laser apparatus of FIG. 1.

Referring to FIGS. 1 to 3, the substrate 10 includes a base layer 10b and a silicon layer 10a.

In one exemplary embodiment, for example, the base layer 10b has a flat shape having a substantially constant thickness. In an exemplary embodiment, the base layer 10b may include an insulating substrate. In such an embodiment, the insulating substrate may include polymer resin such as polyester and epoxy resin, for example, or inorganic material such as ceramic and glass, for example. In an alternative exemplary embodiment, the base layer 10b may include various elements such as a conductive pattern, an insulating layer, etc., and may have various shapes.

The silicon layer 10a is disposed on the base layer 10b. The silicon layer 10a may include polysilicon, amorphous silicon or a mixture thereof, for example.

In one exemplary embodiment, for example, the silicon layer 10a includes an irradiation region R1, a non-irradiation region R3 and a transition region R2. The laser beam 31 may be irradiated in the irradiation region R1 of the silicon layer 10a. The laser beam 31 may not be irradiated in the non-irradiation region R3 of the silicon layer 10a. The transition region R2 is interposed between the irradiation region R1 and the non-irradiation region R3. In one exemplary embodiment, for example, the irradiation region R1 and the non-irradiation region R2 may have a stripe shape and be alternately disposed with each other.

In an exemplary embodiment, the relative location between the stage 20 (or the target, e.g., the substrate 10, on the stage 20) and the laser 30 is controlled such that the laser beam 31 is irradiated only in the irradiation region R1 of the silicon layer 10a. In one exemplary embodiment, for example, the relative location between the stage 20 (or the target, e.g., the substrate 10, on the stage 20) and the laser 30 is controlled by moving the substrate 10 on the stage 20 or the laser 30, such that the light spot of the laser beam 31 on the silicon layer 10a is sequentially moved in a predetermined direction 22 by a predetermined distance (e.g., a width of the non-irradiation region R2), and the laser beam 31 is thereby irradiated only in the irradiation region R1 of the silicon layer 10a. When the laser beam 31 is irradiated in the irradiation region R1 of the silicon layer 10a, the amorphous silicon 16 in the irradiation region R1 is crystallized to form the polysilicon 12.

A periphery of the laser beam 31 has lower intensity than a center of the laser beam 31, such that a portion of the amorphous silicon 16 corresponding to the periphery of the laser beam 31 may be partially crystallized. Thus, the transition region R2 on a periphery of the irradiation region R1 may include a mixture 14 of the amorphous silicon and the polysilicon.

In one exemplary embodiment, for example, the laser beam 31 is selectively irradiated through an advanced excimer laser annealing (“AELA”) method, such that the irradiation region R1 may coexist with the non-irradiation region R3. In an alternative exemplary embodiment, the laser beam 31 may be irradiated through an excimer laser annealing (“ELA”) method or the CW laser method, for example.

In an exemplary embodiment, as described above, the laser device is used to change the amorphous silicon into the polysilicon. In an alternative exemplary embodiment, the laser device may be used to change various materials.

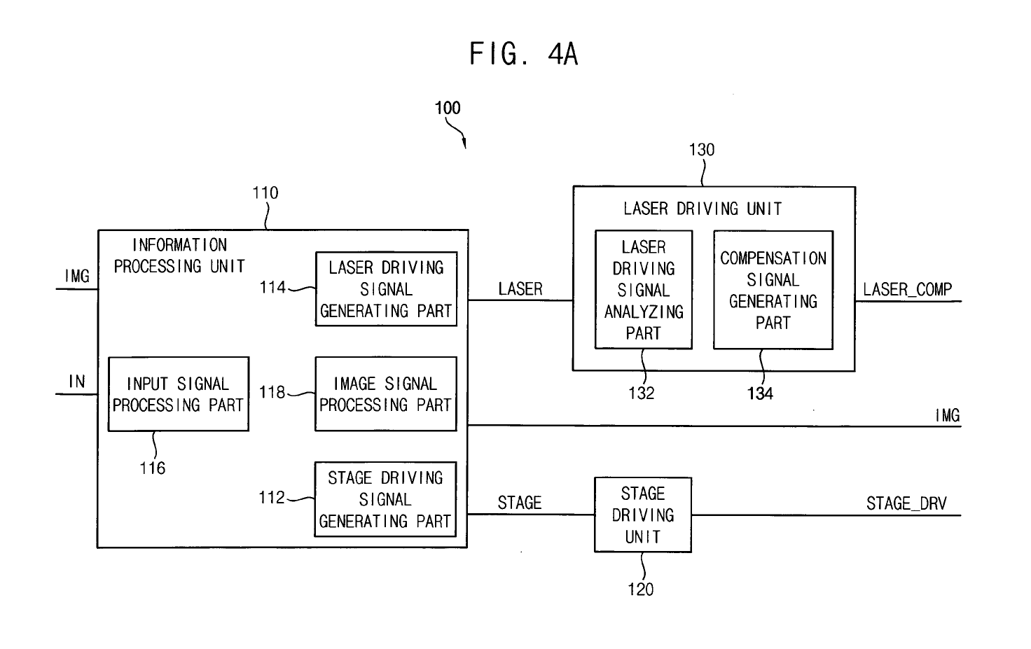

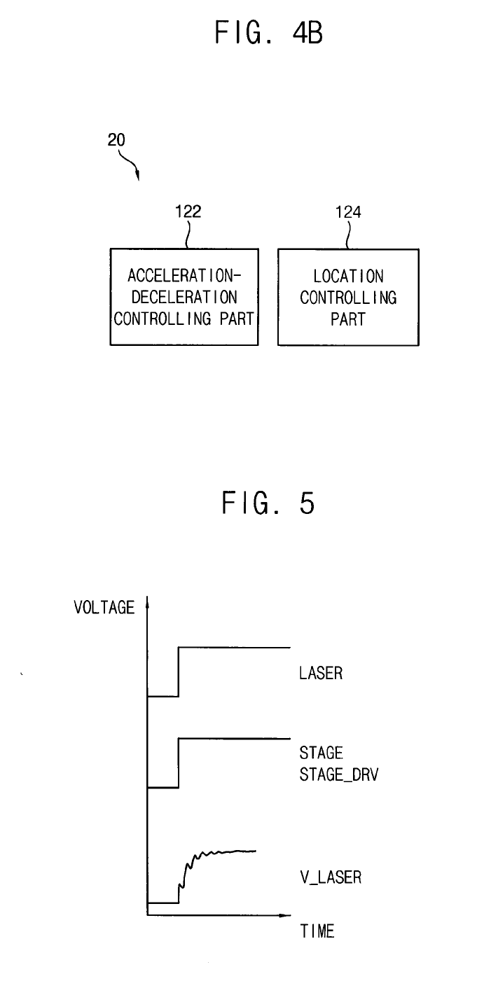

FIG. 4A is a block diagram illustrating a controller of FIG. 1.

Referring to FIGS. 1 and 4A, the controller 100 includes an information processing unit 110, a stage driving unit 120 and a laser driving unit 130. In one exemplary embodiment, for example, the controller 100 has a single module structure. In such an embodiment, where the controller 100 has the single module structure, the controller 100 may have an integrally formed shape having the information processing unit 110, the stage driving unit 120 and the laser driving unit 130.

The information processing unit 110 receives the input signal IN from the input device 40 and the image signal IMG from the camera 35, and applies the image signal IMG, a stage driving signal STAGE and a laser driving signal LASER to the display device 50, the stage driving unit 120 and the laser driving unit 130, respectively.

The information processing unit 110 includes a stage driving signal generating part 112, a laser driving signal generating part 114, an input signal processing part 116 and an image signal processing part 118.

The input signal processing part 116 receives the input signal IN to control the stage driving signal generating part 112, the laser driving signal generating part 114 and the image signal processing part 118 such that the stage driving signal STAGE, the laser driving signal LASER and the image signal IMG are outputted from the stage driving signal generating part 112, the laser driving signal generating part 114 and the image signal processing part 118, respectively.

When the input signal IN inputted to the input signal processing part 116 includes a stage driving information, the stage driving signal generating part 112 generates the stage driving signal STAGE. The stage driving signal STAGE generated from the stage driving signal generating part 112 is applied to the stage driving unit 120. Generally, an AELA typed laser apparatus includes a module for accelerating and decelerating a stage and another module for controlling a location of the stage to drive the stage. However, in an exemplary embodiment, the stage driving signal generating part 112 simultaneously controls a movement of, e.g., the accelerating and decelerating, the stage and the location of the stage.

When the input signal IN inputted to the input signal processing part 116 includes a laser driving information, the laser driving signal generating part 114 generates the laser driving signal LASER. The laser driving signal LASER generated from the laser driving signal generating part 114 is applied to the laser driving unit 130.

When the input signal IN inputted to the input signal processing part 116 includes an image controlling information, the image signal processing part 118 outputs the image signal IMG inputted from the camera 35 to the display unit 50.

The stage driving unit 120 receives the stage driving signal STAGE that is generated from the stage driving signal generating part 112 of the information processing unit 110, and generates a stage driving voltage STAGE_DRV based on the stage driving signal STAGE. The stage driving voltage STAGE_DRV is applied to the stage 20.

The stage 20 changes the location of the substrate 10 thereon based on the stage driving voltage STAGE_DRV. In one exemplary embodiment, for example, the stage driving voltage STAGE_DRV includes a horizontal driving portion and a vertical driving portion to transport the substrate 10 in a horizontal direction or a vertical direction.

FIG. 4B is a block diagram illustrating an exemplary embodiment of the stage 20 of FIG. 1.

Referring to FIGS. 1 and 4B, the stage 20 includes an acceleration-deceleration controlling part 122 and a location controlling part 124. In an exemplary embodiment, the acceleration-deceleration controlling part 122 and the location controlling part 124 are not divided into different modules, but are integrated into the stage driving unit 120 as a single module.

The acceleration-deceleration controlling part 122 controls acceleration and deceleration of the substrate 10 to control the speed of the substrate 10. In one exemplary embodiment, for example, referring again to FIG. 2, the acceleration-deceleration controlling part 122 accelerates the substrate 10 before a starting time point (e.g., a time point at an initial rising edge) of the laser beam 31 in the irradiation region R1 of the substrate 10, and decelerates the substrate 10 after an ending point of the laser beam 31 in the irradiation region R1 of the substrate 10.

The location controlling part 124 controls the location of the substrate 10 such that the location of the laser beam 31 is changed from a position corresponding to an ending point of an irradiation region R1 to a position corresponding to another starting point of an adjacent irradiation region R1.

Referring back to FIGS. 1 and 4A, the laser driving unit 130 receives the laser driving signal LASER generated from the laser driving signal generating part 114 of the information processing unit 110 to generate a laser driving voltage LASER_COMP.

In one exemplary embodiment, for example, the laser driving unit 130 includes a laser driving signal analyzing part 132 and a compensation signal generating part 134.

In an exemplary embodiment, the laser driving signal analyzing part 132 analyzes the laser driving signal LASER to determine characteristics of a compensation signal, which is generated from the compensation signal generating part 134. In one exemplary embodiment, for example, the laser driving signal analyzing part 132 extracts characteristics of the driving signal such as rising time point and voltage level, for example, from the laser driving signal LASER.

In an exemplary embodiment, the compensation signal generating part 134 generates the compensation signal based on the characteristics of the driving signal analyzed by the laser driving signal analyzing part 132. In one exemplary embodiment, for example, a rising time point (e.g., a time point at a rising edge) of the compensation signal generated by the compensation signal generating part 134 may be set to be substantially the same as a rising time point (e.g., a time point at a rising edge) of the laser driving signal LASER, and a voltage level of the compensation signal may be increased in substantially proportional to a voltage level of the laser driving signal LASER.

In such an embodiment, the laser driving unit 130 mixes the laser driving signal LASER with the compensation signal to generate the laser driving voltage LASER_COMP.

In such an embodiment, the laser 30 changes irradiation or non-irradiation of the laser beam 31 and intensity of the laser beam 31 based on the laser driving voltage LASER_COMP.

In an alternative exemplary embodiment, the stage 20 and the laser 30 may be transported in different directions from the horizontal direction and the vertical direction, respectively. In one exemplary embodiment, for example, the stage 20 may be transported only in the horizontal direction, and the laser 30 may be transported only in the vertical direction. In one exemplary embodiment, for example, the stage 20 may be transported only in the vertical direction, and the laser 30 may be transported only in the horizontal direction.

FIG. 5 is a timing diagram illustrating signals and an intensity of laser irradiation of an exemplary embodiment of a laser apparatus according to the invention.

Referring to FIGS. 4A and 5, in such an embodiment, the laser driving unit 130 may not generate the compensation signal. When the compensation signal is not generated, irradiation intensity V_LASER of the laser beam 31 generated from the laser 30 may be unstable in an early stage, as shown in FIG. 5. In such an embodiment, the irradiation intensity V_LASER of the laser beam 31 generated from the laser 30 may be unstable in the early stage, as elements of the laser 30 may not be sufficiently preheated in the early stage. When the elements of the laser 30 are not sufficiently preheated, energy may be lost, and the intensity of the laser beam 31 is thereby decreased. In one exemplary embodiment, for example, the laser beam 31 may be unstable during about 100 nanoseconds (ns) in the early stage.

In such an embodiment, the stage driving unit 120 may generate the stage driving voltage STAGE_DRV synchronized with the stage driving signal STAGE. In an exemplary embodiment, the stage driving signal STAGE may have substantially the same starting time point (e.g., a same time point of an initial rising edge) as the stage driving voltage STAGE_DRV. In such an embodiment, the substrate 10 may be accelerated in the early stage of the stage 20, such that the transportation speed of the substrate 10 may be unstable. When the laser beam 31 is irradiated with the unstable transportation speed of the substrate 10, energy of the laser beam 31 irradiated onto the amorphous silicon may be also unstable.

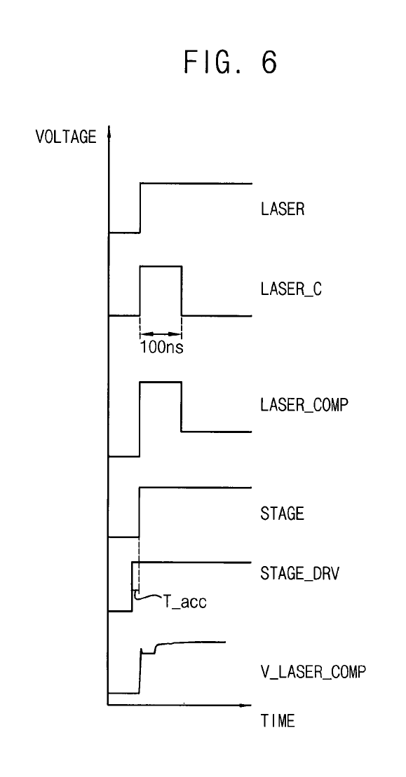

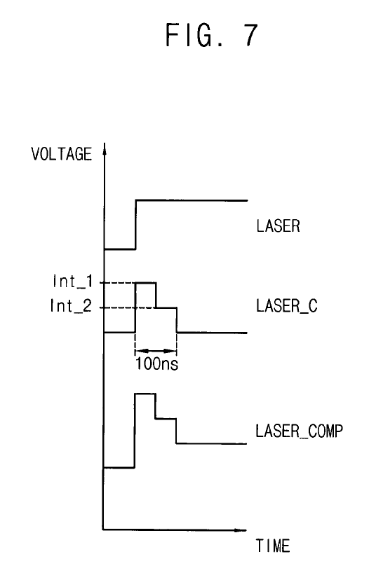

FIG. 6 is a timing diagram illustrating signals and an intensity of laser irradiation of an exemplary embodiment of a laser apparatus show in FIG. 1.

Referring to FIGS. 4A and 6, the laser driving signal analyzing part 132 of the laser driving unit 130 determines the rising time point and the voltage level of the laser driving signal LASER. In one exemplary embodiment, for example, the rising time point of the laser driving signal LASER corresponds to a time point when the laser driving signal LASER is changed from a ground state into a driving state.

In such an embodiment, the compensation signal generating part 134 of the laser driving unit 130 generates a compensation signal LASER_C having a pulse width of which is substantially the same as the unstable period (e.g., about 100 ns as shown in FIG. 5) of the irradiation intensity V_LASER of the laser beam 31. In one exemplary embodiment, for example, the voltage level of the compensation signal LASER_C maintains a high level during the unstable period, e.g., about 100 ns, and then lowered to a lower level corresponding to the ground state. In such an embodiment, the level of the compensation signal LASER_C is maintained at the high level only during about 100 ns from the rising time point of the laser driving signal LASER (e.g., from a time point of the rising edge of the laser driving signal LASER). In one exemplary embodiment, for example, the voltage level of the compensation signal LASER_C is increased, as the length of the unstable period of the laser beam 31 generated without the compensation signal is increased.

In an exemplary embodiment, the laser driving unit 130 generates the laser driving voltage LASER_COMP based on the laser driving signal LASER and the compensation signal LASER_C. In one exemplary embodiment, for example, the laser driving unit 130 mixes the laser driving signal LASER with the compensation signal LASER_C to generate the laser driving voltage LASER_COMP. The generated laser driving voltage has increased voltage level that is greater than a voltage level of the laser driving signal LASER by the compensation signal LASER_C during about 100 ns from the rising time point of the laser driving signal LASER.

In such an embodiment, the irradiation intensity V_LASER_COMP of the laser 30 using the compensation signal LASER_C has a substantially stable intensity from the beginning as shown in FIG. 6. In one exemplary embodiment, for example, the irradiation intensity V_LASER_COMP of the laser 30 may be about 4 volts (V) after about 10 ns from the rising time point of the laser driving signal LASER. When the laser driving voltage LASER_COMP is generated based on the compensation signal LASER_C, a higher voltage, which is higher than the laser driving signal LASER, is applied to the laser 30 during an initial stage of irradiating the laser beam 31, e.g., a predetermined time period after the rising time point of the laser driving signal LASER. When the higher voltage is applied to the laser 30 during the initial stage of irradiating the laser beam 31, the energy loss of the laser beam 31 at the initial stage may be effectively compensated although the elements of the laser 30 is not preheated. In one exemplary embodiment, for example, the laser beam 31 has a substantially stable intensity within a short period of time such as about 10 ns after the rising time point of the laser driving signal LASER.

In such an embodiment, the stage driving unit 120 generates the stage driving voltage STAGE_DRV that precedes the stage driving signal STAGE by the acceleration time T_acc of the substrate. In one exemplary embodiment, for example, the acceleration time may be in a range of about 10 ns to about 100 ns. In one exemplary embodiment, for example, the stage driving signal STAGE has substantially the same starting time point (e.g., a time point at a rising edge) as the laser driving signal LASER, and the stage driving signal has different start point from the stage driving voltage STAGE_DRV. In one exemplary embodiment, for example, the stage driving voltage STAGE_DRV precedes the stage driving signal STAGE by the acceleration time T_acc of the substrate 10, such that the substrate 10 is sufficiently accelerated at the time when the laser beam 31 is irradiated onto the substrate 10. In such an embodiment, the laser beam 31 may not be irradiated onto the substrate 10 during the initial stage of the stage 20 if the speed of the substrate 10 is unstable. Thus, in such an embodiment, the laser beam 31 is irradiated onto the substrate 10 after the substrate is sufficiently accelerated, such that the energy of the laser beam 31 irradiated onto the amorphous silicon may be substantially uniformly distributed. In an alternative exemplary embodiment, the laser driving signal LASER may have substantially the same starting time point (e.g., a same time point of an initial rising edge) as the stage driving voltage STAGE_DRV. In another alternative exemplary embodiment, the laser driving signal LASER may precede the stage driving voltage STAGE_DRV.

FIG. 7 is a timing diagram illustrating signals and an intensity of laser irradiation of an alternative exemplary embodiment of a laser apparatus according to the invention.

Referring to FIGS. 4A and 7, the driving signal analyzing part 132 of the laser driving unit 130 determines the rising time point and the voltage level of the laser driving signal LASER. In such an embodiment, the rising time point of the laser driving signal LASER is defined as a time point at a rising edge of the laser driving signal LASER, that is, a time point when the laser driving signal LASER is changed from a ground state to a driving state.

The compensation signal generating part 134 of the laser driving unit 130 generates a compensation signal LASER_C having a pulse width substantially the same as the unstable period (e.g., about 100 ns of FIG. 5) of the irradiation intensity V_LASER of the laser beam 31. In one exemplary embodiment, for example, the voltage level of the compensation signal LASER_C maintains a first voltage level Int_1 during a first half of the unstable period (hereinafter, a “first 50 ns”), and then maintains a second voltage level Int_2 that is lower than the first voltage level Int_1 during a second half of the unstable period (hereinafter, a “second 50 ns”), and then lowered to a low voltage level corresponding to the ground state after about 100 ns from the rising time point of the laser driving signal LASER. In such an embodiment, the period of about 100 ns from the rising time point is divided into the first 50 ns and the second 50 ns, and the voltage level of the compensation signal LASER_C has the first voltage level Int_1 during the first half and the second voltage level Int_2 during the second half. The first voltage level Int_1 is higher than the second voltage level Int_2. In such an embodiment, the voltage level of the compensation signal LASER_C is higher during the first half than during the second half, and the irradiation intensity of the laser beam 31 is thereby substantially rapidly stabilized.

The laser driving unit 130 generates the laser driving voltage LASER_COMP based on the laser driving signal LASER and the compensation signal LASER_C. In one exemplary embodiment, for example, the laser driving unit 130 mixes the laser driving signal LASER with the compensation signal LASER_C to generate the laser driving voltage LASER_COMP. The generated laser driving voltage has a higher voltage level than the voltage level of the laser driving signal LASER by the compensation signal LASER_C during the 100 ns from the rising time point. In such an embodiment, the laser driving voltage LASER_COMP has a higher voltage level than the laser driving signal LASER by the first voltage level Int_1 during the first 50 ns from the rising time point, and then has a higher voltage level than the laser driving signal LASER by the second voltage level Int_2 during the second 50 ns after the first 50 ns, and then has a voltage level substantially the same as the laser driving signal LASER after about 100 ns from the rising time point of the laser driving signal LASER.

The irradiation intensity of the laser 30 using the compensation signal LASER_C has a substantially stable intensity from the beginning. When the laser driving voltage LASER_COMP includes the compensation signal LASER_C having the two levels of different voltage levels Int_1 and Int_2, the higher voltage is concentrated on the initial stage of the irradiating the laser beam 31. When the higher voltage is applied to the laser 30 during the initial stage of the irradiating the laser beam 31, the energy loss of the laser beam 31 at the initial stage may be effectively compensated although the elements of the laser 30 is not preheated. In one exemplary embodiment, for example, the laser beam 31 has a substantially stable intensity within a short period, e.g., about 10 ns, after the rising time point of the laser driving signal LASER.

The stage driving signal STAGE and the stage driving voltage STAGE_DRV of the exemplary embodiment of laser apparatus shown in FIG. 7 are substantially the same as the stage driving signal and the stage driving voltage of the exemplary embodiment of laser apparatus show in FIG. 6. Thus, any repetitive detained description thereof will be omitted.

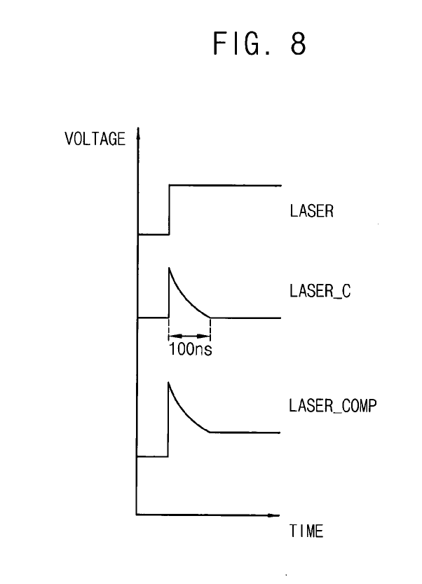

FIG. 8 is a timing diagram illustrating signals and an intensity of laser irradiation of another alternative exemplary embodiment of a laser apparatus according to the invention.

Referring to FIGS. 4A and 8, the driving signal analyzing part 132 of the laser driving unit 130 determines the rising time point and the voltage level of the laser driving signal LASER. In such an embodiment, the rising time point of the laser driving signal LASER is defined as a time point at a rising edge of the laser driving signal LASER, that is, a time point when the laser driving signal LASER is changed from a ground state to a driving state.

The compensation signal generating part 134 of the laser driving unit 130 generates a compensation signal LASER_C having a wavelength substantially the same as the unstable period (e.g., about 100 ns of FIG. 5) of the irradiation intensity V_LASER of the laser beam 31. In one exemplary embodiment, for example, the voltage level of the compensation signal LASER_C has the maximum level at the rising time point, and then substantially continuously decreased after the rising time point, and then lowered to a lower level corresponding to the ground state after about 100 ns from the rising time point. In one exemplary embodiment, for example, the voltage level of the compensation signal LASER_C may have the maximum level at the rising time point of the laser driving signal LASER and then may be decreased along the exponential function. When the voltage level of the compensation signal LASER_C has the maximum level at the rising time point and is then decreased, the irradiation intensity of the laser beam 31 may be substantially rapidly stabilized.

The laser driving unit 130 mixes the laser driving signal LASER with the compensation signal LASER_C to generate the laser driving voltage LASER_COMP. The generated laser driving voltage has increased voltage level higher than the laser driving signal LASER by the compensation signal LASER_C during about 100 ns from the rising time point. That is, the laser driving voltage LASER_COMP has the maximum voltage level at the rising time point, and is then decreased during about 100 ns after the rising time point, and then lowered to the lower level corresponding to the ground state of the laser driving signal LASER after about 100 ns from the rising time point of the laser driving signal LASER.

The irradiation intensity of the laser beam 31 from the laser 30 using the compensation signal LASER_C has a stable voltage level from the beginning. When the laser driving voltage LASER_COMP includes the compensation signal LASER_C having the initial maximum voltage level, the higher voltage is concentrated on the initial stage of the irradiating the laser beam 31. When the higher voltage is applied to the laser 30 during the initial stage of the irradiating the laser beam 31, the energy loss of the laser beam 31 at the initial stage may be compensated although the elements of the laser 30 is not preheated. In one exemplary embodiment, for example, the laser beam 31 has the stable intensity within a short period, e.g., about 10 ns, after the rising time point of the laser driving signal LASER.

The stage driving signal STAGE and the stage driving voltage STAGE_DRV of the exemplary embodiment of laser apparatus shown in FIG. 8 are substantially the same as the stage driving signal and the stage driving voltage of the exemplary embodiment of laser apparatus shown in FIG. 6. Thus, any repetitive detailed description thereof will be omitted.

Table 1 below shows yield of a display apparatus using the polysilicon pattern generated by the laser beam of the exemplary embodiment of laser apparatus shown in FIG. 5 as a semiconductor pattern and a display apparatus using the polysilicon pattern generated by the laser beam of the exemplary embodiment of laser apparatus shown in FIG. 6 as a semiconductor pattern. The total number of scanning the laser beam on the substrate was 414, and the total number of cells of the display apparatuses was 138.

TABLE 1

| | | Black Line | | | Cell Defect | | |
|---|---|---|---|---|---|---|---|
| | | No. of | | | No. of | | |
| | No. of | Black | No. of | Ratio of | Cell | No. of | Ratio of |
| Classification | Experiments | Lines | Scans | Defects | Defects | Cells | Defects |
| FIG. 5 | 23 | 28 | 414 | 6.7% | 20 | 138 | 14.5% |
| FIG. 6 | 23 | 0 | 0 | 0 | 0 | 0 | 0 |

Referring to FIGS. 4A and 4, and Table 1, when the time for stabilizing the laser beam was about 100 ns (FIG. 5), the number of black lines on the substrate was 28, and the number of cell defects was 20.

Thus, the ratio of black line defects was about 6.7%, and the ratio of cell defects was about 14.5%.

Referring to FIGS. 4A and 6, and Table 1, when the time for stabilizing the laser beam was about 10 ns (FIG. 6), no black line was found on the substrate, and no cell defect was found in the cells.

When the time for stabilizing the laser beam was about 100 ns (FIG. 5), the deviation of synchronizing the laser beam was in a range of about 1.2 to about 2.0. However, when the time for stabilizing the laser beam was about 10 ns (FIG. 6), the deviation of the synchronizing the laser beam was about 1.2 to about 1.5. When the deviation of synchronizing the laser beam is decreased, the laser beam may be more precisely controlled.

When the time for stabilizing the laser beam was about 100 ns (FIG. 5), the distribution of energy output of the laser beam was about 0.18 to about 0.29. However, when the time for stabilizing the laser beam was about 10 ns (FIG. 6), the distribution of energy output of the laser beam was in a range of about 0.19 to about 0.25. When the range of the distribution of energy output of the laser beam is decreased, the laser beam may be more precisely controlled.

According to exemplary embodiments, when the time for stabilizing the laser beam is equal to or less than about 10 ns, preciseness of the laser beam is substantially improved. Thus, the irradiation intensity of the laser beam is rapidly stabilized, and yield of the display apparatus is thereby substantially increased.

According to exemplary embodiments of the invention, the initial response speed of the laser apparatus is increased such that the preciseness of the laser is improved. In such embodiments, the irradiation intensity of the laser beam is stabilized within about 10 ns, and the acceleration-deceleration module of the stage may not be separated from the location control module of the stage.

In such embodiments, the laser apparatus effectively prevents or substantially minimizes the defects in crystallizing the substrate. Thus, the defects such as the black line may be substantially decreased or effectively prevented, thereby improving an image display quality of the display apparatus.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A laser apparatus comprising:
a laser which selectively irradiates a laser beam to a portion of a target based on a laser driving voltage, wherein an intensity of the laser beam is substantially stabilized within about 10 nanoseconds;
a stage which controls a relative location between the target and the laser based on a stage driving voltage; and
a controller which applies the stage driving voltage to the stage, and applies the laser driving voltage to the laser.

2. The laser apparatus of claim 1, wherein the laser irradiates the laser beam through an advanced excimer laser annealing method.

3. The laser apparatus of claim 2, wherein the target comprises a base layer, and a silicon layer disposed on the base layer.

4. The laser apparatus of claim 3, wherein the target comprises:
an irradiation region, in which the laser beam is irradiated; and
a non-irradiation region, in which the laser beam is not irradiated.

5. The laser apparatus of claim 4, wherein
when the laser selectively irradiates the laser beam to the portion of the target, the irradiation region comprises polysilicon, and the non-irradiation region comprises amorphous silicon, and
when the laser selectively irradiates the laser beam to the portion of the target, the target further comprises a transition region interposed between the irradiation and non-irradiation regions, wherein the transition region comprises a mixture of polysilicon and amorphous silicon.

6. The laser apparatus of claim 1, wherein the controller has a single module structure.

7. The laser apparatus of claim 6, wherein the controller generates the laser driving voltage and the stage driving voltage based on an input signal.

8. The laser apparatus of claim 7, wherein
the controller generates a laser driving signal, a compensation signal based on the laser driving signal, and the laser driving voltage based on the laser driving signal and the compensation signal.

9. The laser apparatus of claim 8, wherein the controller comprises:
an information processing unit which generates the laser driving signal;
a laser driving unit which generates the laser driving voltage; and
a stage driving unit which generates the stage driving voltage.

10. The laser apparatus of claim 1, wherein the controller changes a stage driving signal into the stage driving voltage.

11. The laser apparatus of claim 10, wherein a starting time point of the stage driving signal is different from a starting time point of the stage driving voltage.

12. The laser apparatus of claim 11, wherein the starting time point of the stage driving voltage precedes the starting time point of the stage driving signal.

13. The laser apparatus of claim 1, wherein the stage comprises:
a location controlling part which controls a location of the target thereon; and
an acceleration-deceleration controlling part which controls an acceleration of the target thereon.

14. A method of irradiating a laser beam using a laser apparatus, the method comprising:
driving a stage of the laser apparatus based on a stage driving voltage, wherein the stage controls a relative location between a target of the laser apparatus and the laser beam irradiated from a laser of the apparatus;
generating a laser driving voltage based on a laser driving signal and a compensation signal, which are generated from a controller of the laser apparatus; and
irradiating the laser beam generated based on the laser driving voltage from the laser to the target.

15. The method of claim 14, wherein the irradiating the laser beam generated based on the laser driving voltage from the laser to the target comprises:
transporting the stage in a vertical direction to irradiate the laser beam in an irradiation region of the target; and
transporting the stage in a horizontal direction without irradiating the laser beam.

16. The method of claim 14, wherein the compensation signal has a high voltage level during an initial stage of the irradiating the laser beam.

17. The method of claim 16, wherein the compensation signal is applied during about 100 nanoseconds from a rising time point of the laser driving signal.

18. The method of claim 16, wherein a voltage level of the compensation signal has a maximum level at a rising time point of the laser driving signal, and then substantially continuously decreases after the rising time point of the laser driving signal.

19. The method of claim 14, wherein an intensity of the irradiated laser beam is substantially stabilized within about 10 nanoseconds.

20. The method of claim 14, wherein the stage is driven at a different starting time point from the irradiating the laser beam.
